(19) United States
(12) Patent Application Publication
(10) Pub. No.: US 2007/0248226 A1
(43) Pub. Date: Oct. 25, 2007

(54) System and method for fast and scalable multimedia authentication in real time environment

(75) Inventors: Chan Fung Chong, Hong Kong (CN); Kam Pui Chow, Hong Kong (CN); Hing Yip Chung, Hong Kong (CN); Chi Kwong Hui, Hong Kong (CN); Kin Ying Yu, Hong Kong (CN); Ka Ying Lai, Hong Kong (CN); Fuk Sang Mak, Kowloon (CN); Shiu Hang Kenneth Tsang, Kowloon (CN)

Correspondence Address: BUCHANAN, INGERSOLL & ROONEY PC, POST OFFICE BOX 1404, ALEXANDRIA, VA, 22313-1404, US

(73) Assignees: THE UNIVERSITY OF HONG KONG, Hong Kong (CN); MULTIVISION INTELLIGENT SURVEILLANCE (HK) LTD., Hong Kong (CN)

(21) Appl. No.: 11/410,004

(22) Filed: Apr. 25, 2006

(51) Int. Cl. H04N 7/167

(52) U.S. Cl. 380/200

(57) ABSTRACT

A method of processing a plurality of digital data files including at least one group of medium data files for constituting a sequence of events or activities of a time interval for secure delivery of the digital data files, the method comprising the steps of: (a) processing a plurality of digital data files so as to generate a file identification value for each digital data file, wherein the file identification value of a digital data file is an one-way arithmetic value characteristic of the data content of the digital data file; (b) processing the file identification values to generate an authentication root value, the authentication root value being an one-way arithmetic value characteristic of the plurality of file identification values; (c) encrypting the root value; and (d) grouping the encrypted authentication root value and a selected plurality of digital data files with a set of authentication information for delivery, wherein the set of authentication information is derived from the file identification values and is for deriving a test root value when in combination with said selected plurality of digital data files, and wherein the test root value is for comparison with the authentication root value to detect tampering of said selected plurality of data files.

### FIELD OF THE INVENTION

This invention relates to authentication of digital medium data. More particularly, the present invention relates to authentication of multi-medium data for secured transportation.

### BACKGROUND OF THE INVENTION

The use of digital data for carrying a medium information, such as pictures, audio and video, has become widespread since the 1990's. With the advent of high performance processors at low costs and more efficient data compression techniques, equipment for converting medium information into digital data files, for example, digital cameras, digital video equipment and MPEG compatible devices, are available to the general public at very affordable costs while offering reasonable or high performance. The proliferation of internet users in recent years plus the ease and convenience associated with the transportation of digital medium files on the internet have rapidly made digital medium as the main stream for use by the general public.

As medium information is carried by digital data in the digital world and tampering of digital data files is always a concern in the digital information technology world, issues relating to authentication of digitized medium information have become increasingly important. In general, authentication is the process of proving the identity or authenticity of the content, owner and creation date of a document or a piece of information. Data authenticity is of particular importance if a medium information carries certain evidential value. Photographs or moving pictures, for example, those recorded by a surveillance camera, may be used as evidence in support of criminal prosecution or for investigative purposes. In such circumstances, the integrity and authenticity of the data will come under close examination and scrutiny, and the authenticity of the medium information may be pivotal in such cases.

In the physical world, the question of authenticity can be examined by the more traditional forensic methods which are based on examination of the physical and/or chemical properties of a piece of evidence. In the digital world, however, information is carried in a digital format comprising data of the form “1” or “0”. It is well known that digital data is prone to tampering unless security or authentication schemes are applied.

For authentication of digital medium information, especially digital multimedia authentication, there are two main types of authentication mechanisms, namely, digital watermarking and digital signature. Digital signature is a kind of stenography and is a technology characterized by the injection of hidden information into multimedia data. Although digital watermarking is known to be reasonably robust and tamper resistive, its security relies on a secret key which must be presented for retrieving the watermark. The requirement of a secret key means a digital watermark cannot be publicly verifiable. A disadvantage of digital watermarking is that it can only provide a relatively weak authentication as the exact location at which modification of the medium information has occurred cannot be detected.

Digital signature is based on cryptographic methods, especially public key cryptography (PKC), is widely used for authentication applications. An authentication scheme utilizing public key cryptography utilizes a private key to send a message and then a public key is used to verify the authenticity of the message. RSA, Diffie-Hellman Elliptic curve and El-Gamal are the better-known algorithms commonly used in public key cryptography. Although digital signature provides for a very useful tool for authentication, an efficient generation of a digital signature for video data application is difficult to achieve using this technique. In particular, the necessary logic calculation cannot be performed efficiently by a video hardware because the calculation usually requires modular exponentiation for a large integer.

Furthermore, for many real-time applications, the rate of media or multimedia data generation from a source can be prohibitively high so that neither a digital watermarking scheme nor the digital signatures are provide appropriate suitable techniques.

It is an object of the present invention to provide a method of processing medium data files which overcomes at least some of the disadvantages associated with the techniques of the prior art.

### SUMMARY OF THE INVENTION

Broadly speaking, the present invention has described a method of a method of processing a plurality of digital data files including at least one group of medium data files for constituting a sequence of events or activities of a time interval for secure delivery of the digital data files, the method comprising the steps of:—
a) processing a plurality of digital data files so as to generate a file identification value for each digital data file, wherein the file identification value of a digital data file is an one-way arithmetic value characteristic of the data content of the digital data file;
b) processing the file identification values to generate an authentication root value, the authentication root value being an one-way arithmetic value characteristic of the plurality of file identification values;
c) encrypting the root value; and
d) grouping the encrypted authentication root value and a selected plurality of digital data files with a set of authentication information for delivery, wherein the set of authentication information is derived from the file identification values and is for deriving a test root value when in combination with said selected plurality of digital data files, and wherein the test root value is for comparison with the authentication root value to detect tampering of said selected plurality of data files.

This method obviates the need of a digital signature for each individual medium data file so that security transportation can be achieved at a relatively low computational overhead and at the same time facilitating public verification of the data content.

Preferably, the method comprises construction of an authentication tree from said digital data files, said authentication tree having a root characterized with said root value, a plurality of leave nodes formed from the file identification values of said plurality of digital data files and a plurality of intermediate nodes derived from said leave nodes through one-way arithmetic operations of said file identification values, said intermediate nodes being intermediate the leave nodes and the root, said authentication tree being characterized by a plurality of authentication paths and each intermediate node is associated with an authentication path providing for establishment of the root value of the authentication tree from said intermediate node and the associated authentication paths associated with said intermediate node, the authentication path of an intermediate node is characterized by intermediate nodes which are siblings of said intermediate node, wherein said selected plurality of digital data files which are grouped for delivery comprising a plurality of medium data files for constituting a group of pictures and being under an intermediate node. The employment of a tree structure, especially a binary tree structure, facilitates an efficient authentication scheme particularly suitable for video and/or multi-medium applications.

Preferably, the root value of the authentication tree is encrypted by a digital signature scheme. This ensures a secured transmission of the root value for reliable authentication at destination.

Preferably, the file identification value of a digital medium data file is generated by one-way function such as a hash function. The use of one-way functions alleviates the risk of tampering of the individual medium data files.

Preferably, the medium data files comprise moving picture files or video data files. This method is particularly attractive for video application since a video recording is characterized by a voluminous generation of video data in a short period of time so that generation of individual digital signature for each picture frame or packet would be computationally extensive and impractical.

Preferably, wherein the video data files is in MPEG-4 or like formats.

Preferably, a plurality of medium data files and with their corresponding authentication paths are grouped for subsequent transmission, the plurality of medium data files forms moving pictures of a predetermined time period. This method is particularly advantageous for video recording comprising medium data files arranged in groups of pictures so that a single digital signature will be sufficient for a group of pictures.

According to another aspect of this invention, there is provided a method of verifying integrity of medium data files transmitted according to the aforementioned methods and comprising the steps of:—
a) decrypting a received root value;
b) calculating the file identification values from the received medium data files;
c) calculating a root value from said file identification values and said set of authentication information by one-way arithmetic operations; and
d) comparing for equality the calculated root value and the received encrypted root value.

According to yet another aspect of this invention, there is provided an apparatus for processing digital medium data files for transmission, the apparatus comprising:—
a) a hash value generator for processing a plurality of digital medium data files so as to generate a plurality of file identification values, the file identification value of a digital medium data file is characteristic of its medium data;
b) an authentication tree generator for processing the plurality of file identification values to form an authentication tree, the authentication tree having a root with a root value and with the plurality of digital medium data files forming leaves of the authentication tree, the authentication tree being characterized by a plurality of authentication paths, each digital medium data file being associated with an authentication path such that the root value of the authentication tree can be established from an digital medium data file and its associated authentication path;
c) an encryption unit for encrypting the root value of the authentication tree; and
d) a group unit for grouping the encrypted root value, a plurality of digital medium data files and their respective associated authentication paths for transmission

According to yet another aspect of this invention, there is provided an apparatus for verifying integrity of medium data files transmitted according to the aforementioned method and comprising:—
a) a decryption unit for decrypting received root value;
b) processing unit for calculating the file identification values from the received medium data files;
c) a processing unit for constructing an authentication tree using the file identification values and the authentication paths received and calculating a root value of the authentication tree; and
d) a comparison unit for comparing for equality the calculated root value and the received encrypted root value.

### BRIEF DESCRIPTION OF THE DRAWINGS

Preferred embodiments of the present invention will be explained in further detail below by way of example and with reference to the accompanying drawings, in which:—

FIG. 1 is a schematic diagram showing a multi-channel video capturing system with picture processing means for secure transmission in a first preferred embodiment of this invention,

FIG. 2 is a schematic diagram showing a complete authentication tree for the system of FIG. 1,

FIGS. 3a, 3b, 3c and 3d respectively show the schematic authentication tree of channels 1, 2, 3 and 4 of the video system of FIG. 1,

FIG. 4 shows an authentication tree for the video system of FIG. 1 in a second preferred embodiment of this invention,

FIGS. 5a, 5b, 5c and 5d respectively show a schematic authentication tree for channels 1, 2, 3 and 4 of the video system of FIG. 1 in a second preferred embodiment of this invention,

FIG. 6a is a schematic diagram showing the reconstruction of a partial authentication path as an intermediate step for verifying the authenticity of a plurality of received medium content data files,

FIG. 6b shows yet a further step in the reconstruction of a partial authentication tree from the partial authentication path of FIG. 6a,

FIG. 6c shows a further step of reconstruction of a partial authentication tree from that of FIG. 6b,

FIG. 6d shows a final step in the reconstruction of an authentication path up to the computation of the root value for verification of the received medium data file characterized with the hash values of FIG. 6a,

FIG. 7 shows a schematic authentication tree illustrating a third preferred embodiment of this invention,

FIG. 7a shows an exemplary partial authentication tree for packet 1 of stream 1 of FIG. 7,

FIG. 7b shows an exemplary authentication tree of Channel 1 of FIG. 7,

FIG. 7c shows another exemplary authentication tree of Channel 1 and Channel 2 of FIG. 7,

FIG. 8 is a schematic diagram showing a series of VSBs,

FIG. 8a shows in detail an exemplary VSB,

FIG. 8b shows an exemplary data structure of a VSB,

FIG. 9a illustrates yet another exemplary authentication tree, and

FIG. 9b illustrates the authentication path information for Channel 1, Channel 2 and Packet 1 of the exemplary authentication tree of FIG. 9a.

### DETAILED DESCRIPTION OF THE INVENTION

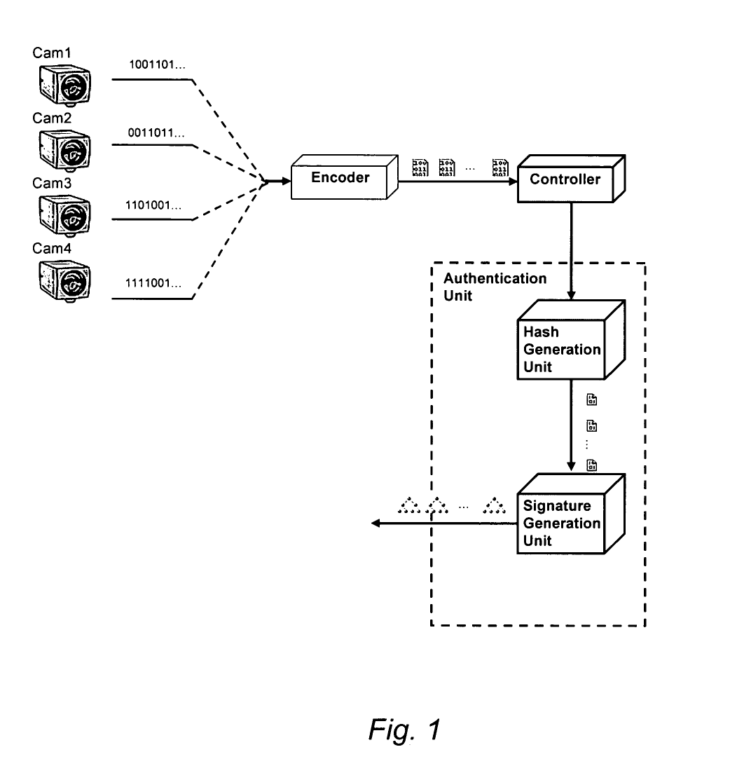

Referring to the drawings, and more particularly to FIG. 1, an embodiment of a video capturing system according to the present invention is shown which comprises a plurality of picture capturing devices, an encoder, a controller and an authentication unit. Each picture capturing device is adapted for capturing an optical image and for converting the captured optical image into a stream of digital data, such as a digital video content file. A more sophisticated picture capturing device may comprise a means for outputting a digital multi-medium data file containing additional information such as audio, text, motion vector, timestamp and identity of the picture capturing device in addition to video data. A basic capturing device can be a pin-hole camera while a more sophisticated picture capturing device may comprise a video recorder with an audio input and a data bank for supplying time and identity information.

The encoder is adapted for converting a digital medium content file into an encoded or compressed data file. The output of the encoder is fed into the controller which is adapted for controlling the picture recording process and the transmission of the encoded digital medium content files.

The authentication unit comprises a hash generation unit and a signature generation unit. The hash generation unit is adapted to generate a file identification value from a digital medium content file. A file identification value of a digital medium content file is characteristic of its medium content. Typically, a file identification value of a digital medium content file is a hash value generated by a one-way function, such as a hash function, by processing the medium data contained in the file. The timestamp can be used as a unique index of a specific data file in a stream of data file. The output hash value, the timestamp, the channel ID and the stream ID will be sent to the signature generation unit for processing. After the hash values have been calculated, an authentication tree is built.

The authentication tree is built on the medium data files with the file identification values of the individual medium data files as the leaves. The Merkle Hash Tree, initially described in the article: “A Digital Signature Based On a Conventional Encryption Function”, R. Merkle, Proceedings of Crypto '87, pp. 369-378, and then described in the article “Fractal Merkle Tree Representation and Traversal” by M. Jakobsson, T Leighton, S. Micali, and M. Szydlo, published on wwwrsasecurity.com, is an example of a suitable authentication tree for this application. The two published articles are incorporated herein by reference.

More particularly, the authentication tree is built with the hash values of the individual medium data files as the leaves. The leaves are grouped and processed to form intermediate or interior nodes which are in turn grouped and processed until a single root is generated. A plurality layers of intermediate nodes are formed depending on the number of leaves and each node layer is denoted by a layer height. For an authentication tree with a complete binary tree structure, the tree has height H and it has 2H leaves and 2^{H}-1 interior nodes. The node heights range from “zero” (leaves) to “H” (the root) and the parent's interior node values are one-way functions of the children's interior node values such that:—
P(nₚₐᵣₑₙₜ)=hash(P(n_{left})IIP(n_{right})),

where the altitude of any node n is the height of the maximum subtree for which it is the root, hash denotes the one-way function and a possible one-way function is SHA-1, MD2, MD5 and other appropriate hash functions. In addition, there is an assignment of a string of a predetermined length to each node in accordance with established hash functions. After the root value has been generated, a video signature will be generated.

To generate a video signature, the hash values together with the various identification information will be sent to the signature generation unit. The identification information may include, for example, the timestamp, channel identification and stream type identification for a particular data block.

The signature generation unit will store the hash values and the identification information of a data block in its storage, such as its memory device. When a predetermined number of digital medium content files have been received, for example, a set of digital medium content files retained within a specific time interval of say, 5 seconds, the signature generation unit will construct an authentication tree so that the medium content files can be subsequently authenticated.

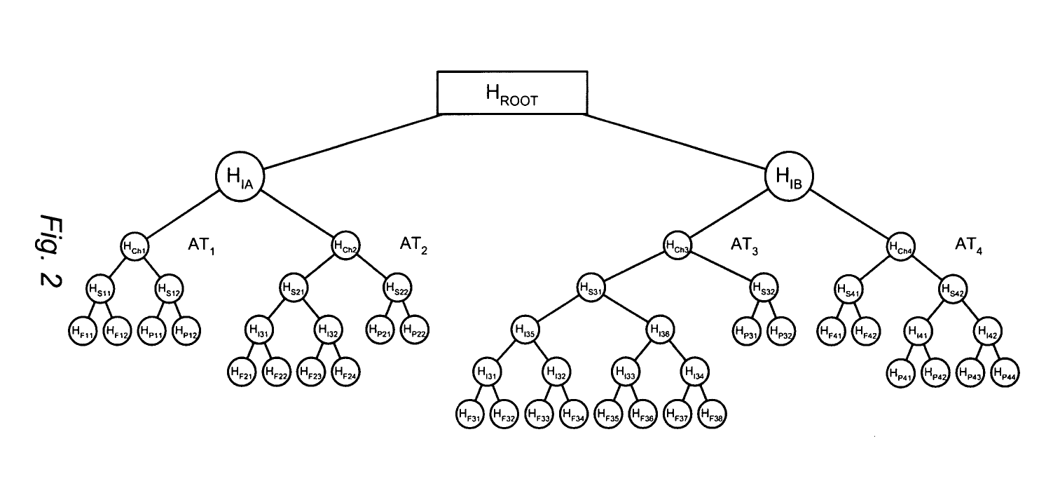

FIG. 2 shows an authentication tree of FIG. 1 in a first preferred embodiment for a specific time interval. In this preferred embodiment, multi-medium data, for example, video data, audio data and text-overlay, are output from the capturing devices. The multi-medium data comprises basic building blocks of “frames” and “packets”. Frames are generated sequentially in chronological order and are the building blocks of a video data stream. Other data are typically arranged in packets. The exemplary system of FIG. 1 comprises a plurality of picture capturing devices each of which forms a multi-medium data channel. Such a channel generates a plurality of medium data streams, which can be for example, audio, video or text-overlay.

For the specific time interval, the video and/or multi-medium data collected by the individual picture capturing devices after encoding and compression are as follows: —

Channel 1—2 frames, namely, F₁₁, F₁₂

2 packets, namely, P₁₁, P₁₂

Channel 2—4 frames, namely, F₂₁, F₂₂, F₂₃, F₂₄

2 packets, namely, P₂₁, P₂₂

Channel 3—8 frames, namely, F₃₁, F₃₂, F₃₃, F₃₄, F₃₅, F₃₆, F₃₇, F₃₈

2 packets, namely, P₃₁, P₃₂

Channel 4—2 frames, namely, F₄₁, F₄₂

4 packets, namely, P₄₁, P₄₂, P₄₃, P₄₄

In this example, the group of medium files comprising frames F₁₁, F₁₂ and packets P₁₁, P₁₂ together constitute a sequence of events or activities, such as a video stream or an audio stream. Likewise, the group of medium files comprising frames F₂₁, F₂₂, F₂₃, F₂₄ and packets P₂₁, P₂₂ together constitute another sequence of events or activities of Channel 2. When the medium content files arrived at the controller, they are fed into the hash generation unit and the hash values are generated as follows: —

Channel 1—H_{F11}, H_{F12}, H_{P11}, H_{P12}

Channel 2—H_{F21}, H_{F22}, H_{F23}, H_{F24}, H_{P21}, H_{P22}

Channel 3—H_{F31}, H_{F32}, H_{F33}, H_{F34}, H_{F35}, H_{F36}, H_{F37}, H_{F38}, H_{P31}, H_{P32}

Channel 4—H_{F41}, H_{F42}, H_{P41}, H_{P42}, H_{P43}, H_{P44}

Throughout this specification, the capital H is used as a symbol for hash operator. For example, the symbol H_{Fnn} or H_{Pnn} means the hash value of Fₙₙ or Pₙₙ. The term “medium data file” and “medium data file” is interchangeable used.

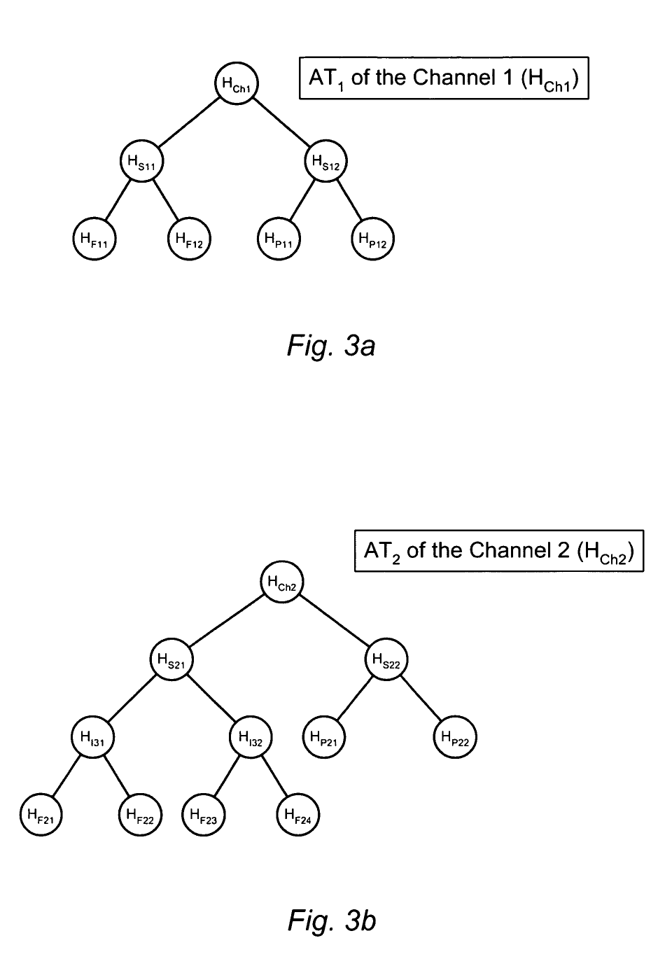

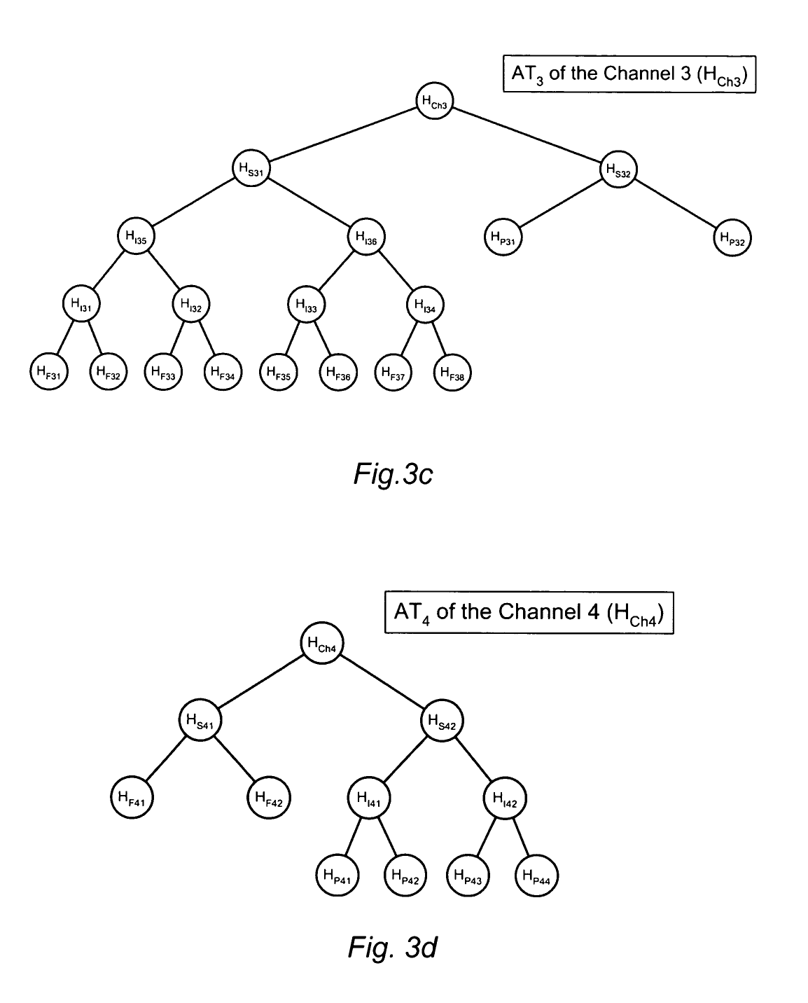

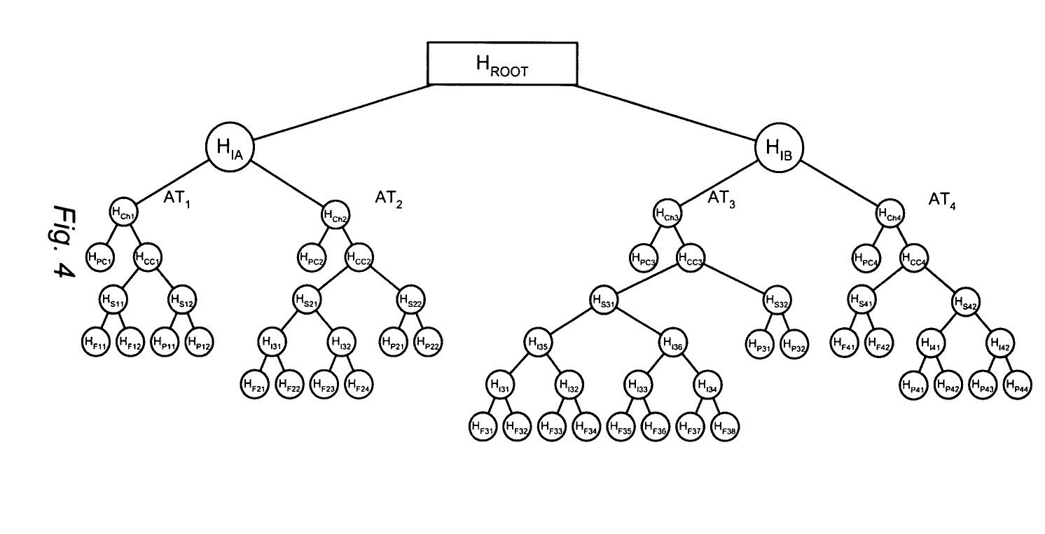

For secure transportation of the medium content files, a plurality of outputs each comprising (1) a leaf pre-image, which is a medium content file giving rise to the leave; and (2) the authentication path of the leaf, i.e., the values of all nodes that are siblings of nodes on the path between that leaf and the root, are generated and delivered. To verify the value of a medium content file, that is, a leaf pre-image, the potential values of the ancestors are calculated by iterated hashing utilizing the authentication path and a leaf pre-image is accepted as authentication if and only if the computed root value is equal to the known root value which is transported. The component authentication trees for the construction of the entire authentication tree are described below. Specifically, the Authentication Tree (AT) of the current Channel 1 is shown in FIG. 3.

In FIG. 3a, the nodes H_{F11}, H_{F12}, H_{P11}, H_{P12} are leaf nodes and the nodes H_{S11}, and H_{S12} are intermediate nodes each having a characteristic intermediate node value which is derived from a one-way arithmetic operation on the immediately depending leaves. Specifically, H_{S11} is a hash value of H_{F11} & H_{F12} obtained from an appropriate hash function and H_{S12} is a hash value of Hₚ₁₁ & Hₚ₁₂ obtained from the same hash function. The channel node hash value (H_{Ch1}) is a hash value of the intermediate node hash values H_{S11} and H_{S12}. Similarly, the AT for other channels are shown in FIGS. 3b, 3c and 3d.

In FIG. 3b, the nodes H_{F21}, H_{F22}, H_{F23}, H_{F24}, H_{P21}, H_{P22} are leaf nodes of AT₂, the nodes H_{I21}, H_{I22}, H_{S21} and H_{S22} are intermediate nodes each having a characteristic intermediate node value which is derived from a one-way arithmetic operation on the immediately depending leaves. Specifically, H_{I21} is a hash value of H_{F21} & H_{F22}, H_{I22} is a hash value of H_{F23} & H_{F24}, and H_{S22} is a hash value of H_{P11} & H_{P12}. Also, H_{S21} is a hash value of the intermediate node hash values H_{I21}, H_{I22}. The channel node hash value (H_{Ch2}) is a hash value of the intermediate node hash values H_{S21} and H_{S22}. Similarly, the authentication tree for Channels 3 & 4, namely, AT₃ & AT₄, are shown respectively in FIGS. 3c and 3d and the same symbol convention applies as used previously.

The complete AT of this specific time interval is constructed by the authentication trees of the 4 channels as shown in FIG. 2.

Next, the root value of the AT, H_{ROOT}, is digitally signed. The Authentication Paths (AP) for the channels are computed as follows:—

Channel 1: {(H_{Ch2}, RIGHT), (H_{IB}, RIGHT)}

Channel 2: {(H_{Ch1}, LEFT), (H_{IB}, RIGHT)}

Channel 3: {(H_{Ch4}, RIGHT), (H_{IA}, LEFT)}

Channel 4: {(H_{Ch3}, LEFT), (H_{IA}, LEFT)}

When the digital medium content files, for example, F₁₁, F₁₂, P₁₁, and P₁₂ in case of Channel 1, are sent with the relevant AP, that is, the AP for Channel 1, a root value can be computed for verification with the publicly received and signed root value.

In a second preferred embodiment of the multi-medium system of FIG. 1, the contents of the immediately preceding interval of each of the channels are used to build the authentication tree. Specifically, the hash values of each of the channels of the immediately preceding time interval are used. In the following H_{PCn} means the hash value of the immediately preceding hash value of channel n and the authentication trees are as follows:—

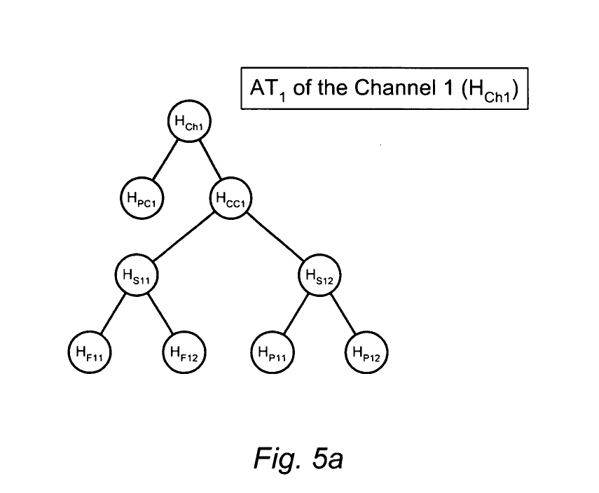

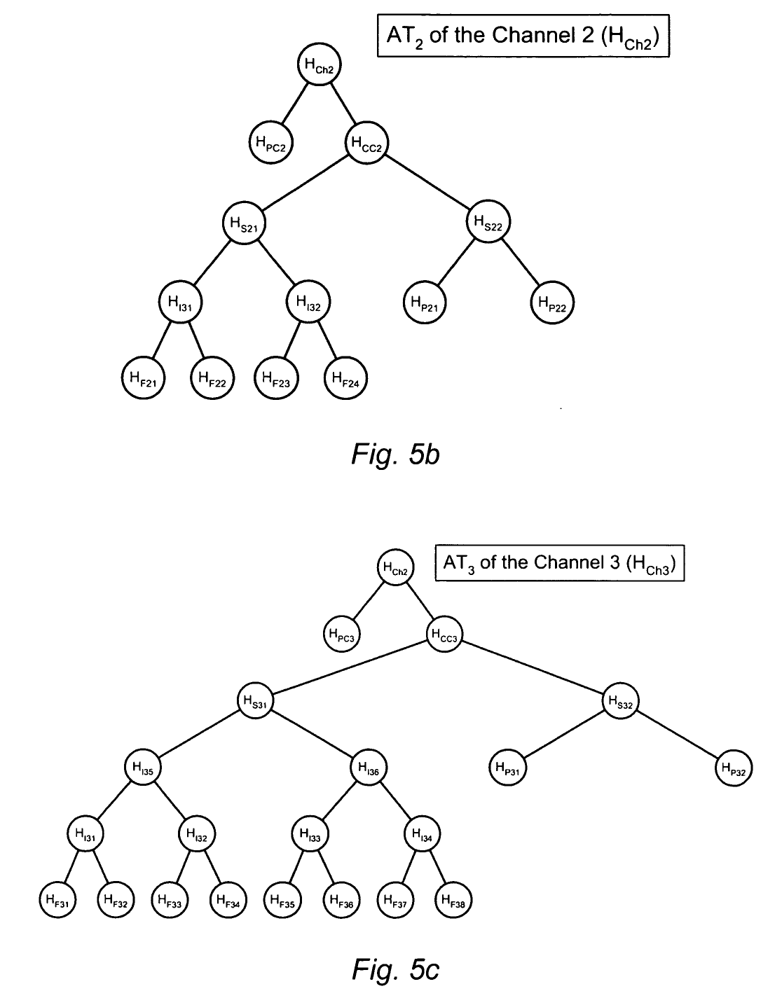

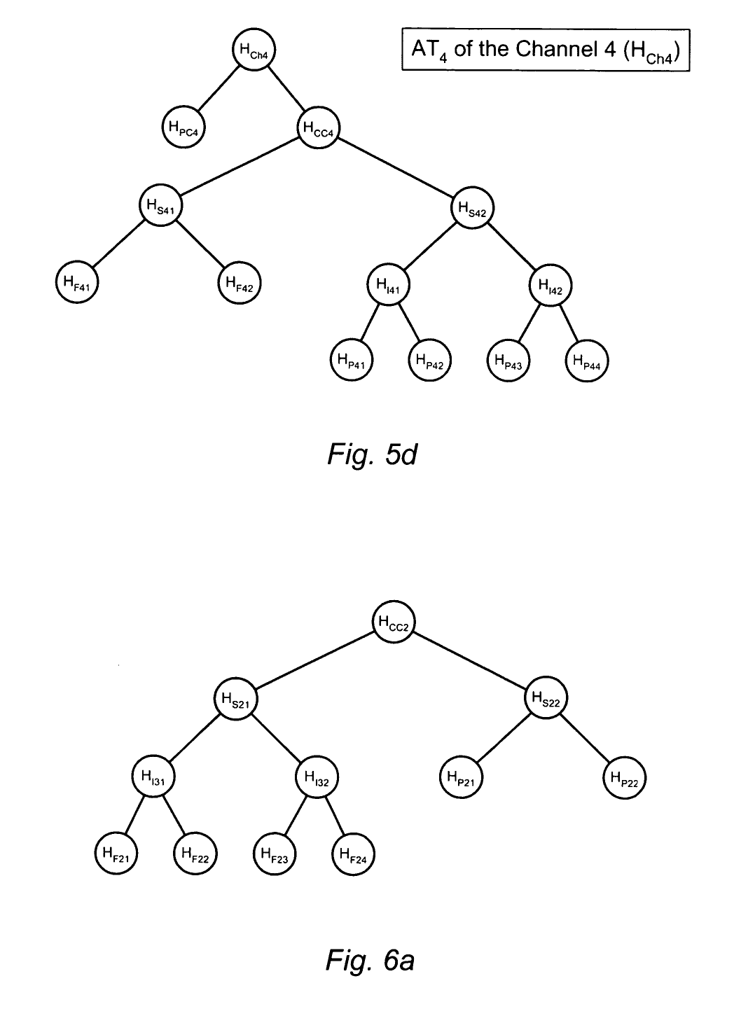

For Channel 1, AT₁ is as shown in FIG. 5a.

For Channel 2, AT₂ is as shown in FIG. 5b.

For Channel 3, AT₃ is shown in FIG. 5c.

For Channel 4, AT₄ is as shown in FIG. 5d.

The complete authentication tree of this second preferred embodiment is shown in FIG. 4.

The root value of the AT, H_{ROOT}, is signed digitally and the Authentication Paths (AP) for the channels are computed:—

Channel 1: {(H_{PC1}, LEFT), (H_{Ch2}, RIGHT), (H_{IB}, RIGHT)}

Channel 2: {(H_{PC2}, LEFT), (H_{Ch1}, LEFT), (H_{IB}, RIGHT)}

Channel 3: {(H_{PC3}, LEFT), (H_{Ch4}, RIGHT), (H_{IA}, LEFT)}

Channel 4: {(H_{PC4}, LEFT), (H_{Ch3}, LEFT), (H_{IA}, LEFT)}

In the various partial authentication trees, the following keys apply:—

Keys

| | |
|---|---|
| 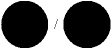 | Leave nodes; Frames/packets; |
| 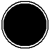 | Intermediate nodes; (For building up the binary tree, not representing and components;) |
| 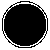 | Intermediate nodes; Streams; |
| 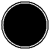 | Intermediate nodes; Current channel; |
| 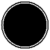 | Intermediate nodes; Previous channel (channel node on the previous AT of the same channel); |
| 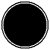 | Root node of the channel; |

The medium content files are delivered together with a video signature block (VSB) which contains the necessary authentication information. In particular, there is one VSB for one channel in every time interval. Specifically, the Video Signature Blocks for the channels at a specific time interval contain the following:—

VSB of Channel 1
Digital Signature:Signed H_{ROOT}
Authentication Path:{(H_{PC1}, LEFT), (H_{Ch2}, RIGHT), (H_{1B}, RIGHT)}
Hash values:H_{F11}, H_{F12}, H_{P11}, H_{P12}

VSB of Channel 2
Digital Signature:Signed H_{ROOT}
Authentication Path:{(H_{PC2}, LEFT), (H_{Ch1}, LEFT), (H_{1B}, RIGHT)}
Hash values:H_{F21}, H_{F22}, H_{F23}, H_{F24}, H_{P21}, H_{P22}

VSB of Channel 3
Digital Signature:Signed H_{ROOT}
Authentication Path:{(H_{PC3}, LEFT), (H_{Ch4}, RIGHT), (H_{IA}, LEFT)}
Hash values:H_{F31}, H_{F32}, H_{F33}, H_{F34}, H_{F35}, H_{F36}, H_{F37}, H_{F38}, H_{P31}, H_{P32}

VSB of Channel 4
Digital Signature:Signed H_{ROOT}
Authentication Path:{(H_{PC4}, LEFT), (H_{Ch3}, LEFT), (H_{IA}, LEFT)}
Hash values:H_{F41}, H_{F42}, H_{P41}, H_{P42}, H_{P43}, H_{P44}

Upon receipt of the medium content files and the VSB, which contains the authentication information, a recipient of the medium content files can verify the integrity of the received data by reconstruction of the authentication trees based on the received medium content file(s) and the authentication information. For example, assuming the medium files to be verified are from Channel 2, the frames/packets belonging to a time interval will be verified in a single verification. The data blocks are verified against the VSB generated for that specific time interval) in the following exemplary manner.

Data to be Verified

4 Frames: F₂₁, F₂₂, F₂₃, F₂₄

2 packets: P₂₁, P₂₂

Content of the VSB at Hand

Digital Signature:Signed H_{ROOT}

Authentication Path:{(H_{PC2}, LEFT), (H_{Ch1}, LEFT), (H_{IB}, RIGHT)}

Hash values:H_{F21}, H_{F22}, H_{F23}, H_{F24}, H_{P21}, H_{P22}

Step 1

Calculate the hash values of each element (i.e. F₂₁, F₂₂, F₂₃, F₂₄, P₂₁, P₂₂)

Obtained H_{F21}, H_{F22}, H_{F23}, H_{F24}, H_{P21}, H_{P22}

Step 2

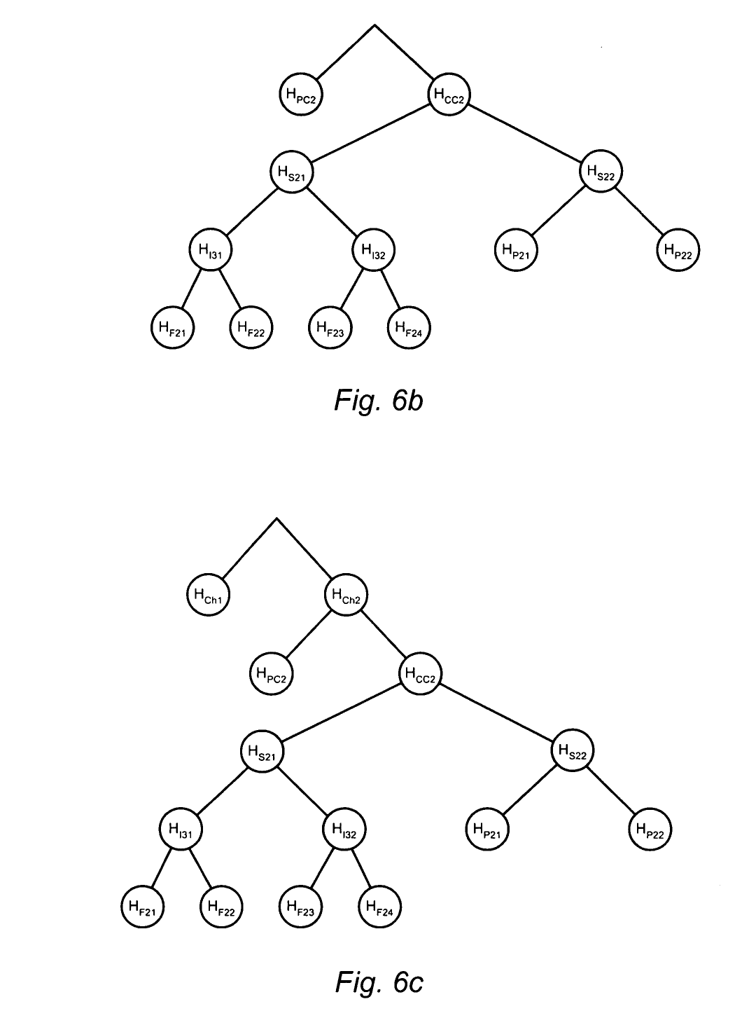

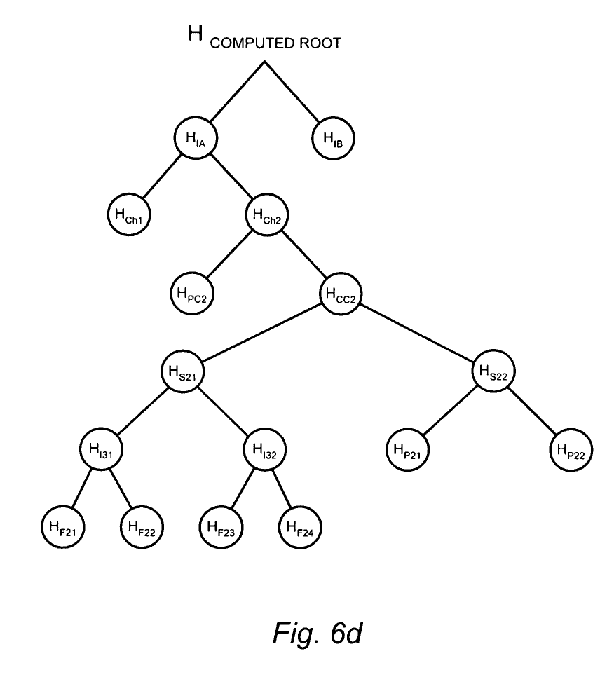

Reconstruct the partial Authentication Path with the calculated hash values, as shown in FIG. 6a.

Step 3

Rebuild the root value of Channel 2, i.e., H_{Ch2}, from the information contained in the Authentication Path of the VSB and using {(H_{PC2}, LEFT), (H_{Ch1}, LEFT), (H_{IB}, RIGHT)}, as shown in FIG. 6b.

Next, H_{IA} is derived from {(H_{PC2}, LEFT), (H_{Ch1}, LEFT), (H_{IB}, RIGHT)}, as shown in FIG. 6c.

Finally, the root value is computed from {(H_{PC2}, LEFT), (H_{Ch1}, LEFT), (H_{IB}, RIGHT)}, as shown in FIG. 6d.

Step 4

Next, the computed root value, H_{COMPUTED ROOT} is checked against the Signed H_{ROOT} contained in the received VSB.

The data are considered valid if H_{COMPUTED ROOT} is equal to the Signed H_{ROOT}.

In a third preferred embodiment of this invention, the system is adapted for transmission of multi-medium data comprising video encoded in the MPEG-4 format. The MPEG-4 standard is becoming a popular format for streaming multi-media on the Internet. MPEG-4 encodes a bit-stream in groups of different frame types (I, P and B frames), where the I-frame is independent, while the P- and B-frames depend on the I-frame in the group. Specifically, the I-frame is an entire picture frame of video encoded in JPEG and the P-frame contains the “difference” between a subsequent video frame and the previous video frame. Thus, losing an I-frame will cause a noticeable worsening of the video quality of all the frames in the group.

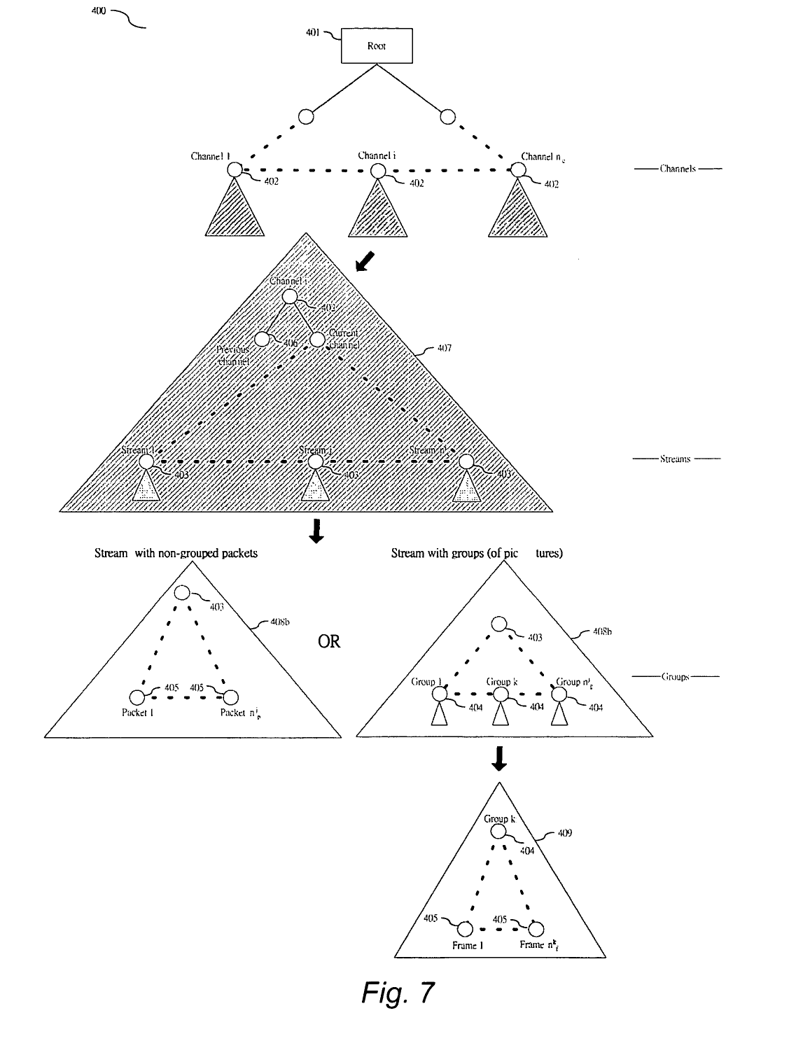

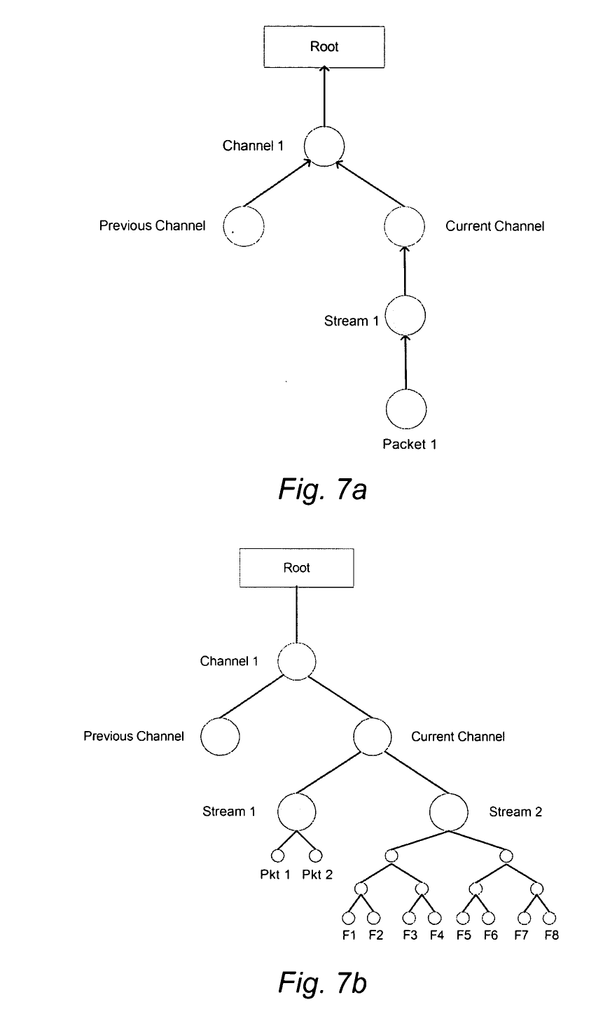

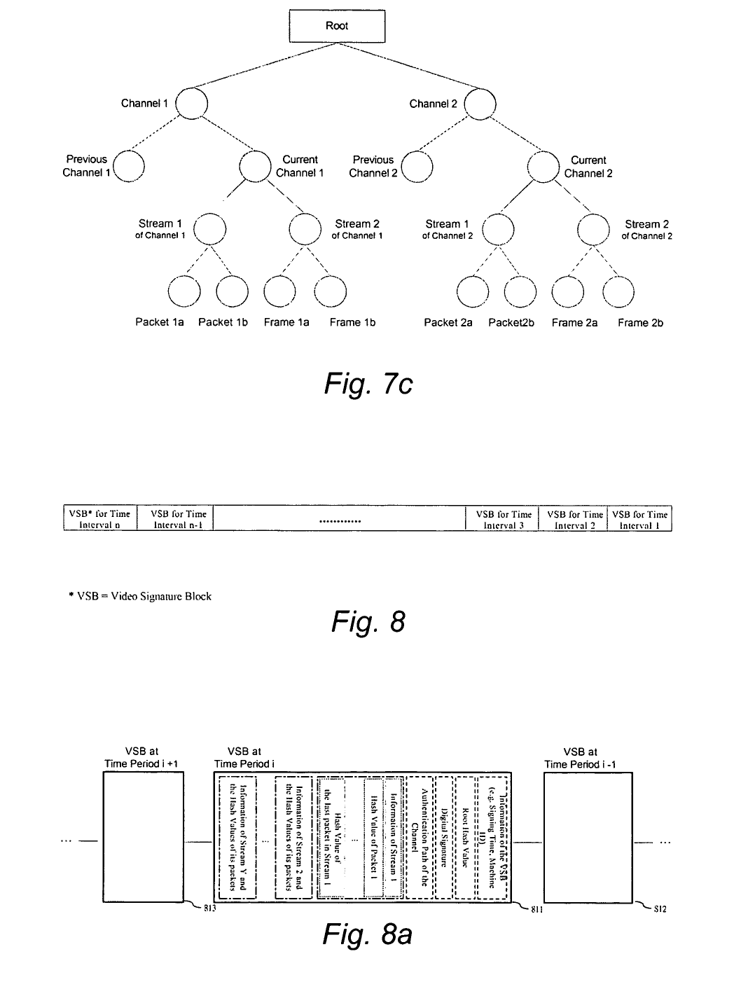

The MPEG-4 standard arranges video data in groups of pictures (GOP) comprising a single I-frame and a plurality of P-frames. Groups of pictures are demarcated by I-frame intervals, that is, two consecutive I-frames are the bounding frames of a group of pictures and the P-frames in between a pair of consecutive I-frames belong to the same GOP. The use of group of pictures facilitates more efficient video extraction because frames within an I-frame interval (which is generally regarded as the minimum unit for video extraction) are arranged together and can be extracted separately. A schematic authentication tree of this embodiment is shown in FIG. 7 in which the system has been generalized to contain n channels, namely, Channel 1 to Channel n. The authentication tree of each channel (channel i is shown as an example) is built from the hash values of the previous channel and the current channel. The current channel comprises a plurality of data streams, namely, streams 1, . . . stream j, . . . steam n.

Each of the streams may be a stream of non-grouped packets or a stream of groups of pictures (GOP). Each grouped stream may comprise a plurality of groups in which each group may in turn comprise a plurality of frames, namely, frames 1-n.

An exemplary authentication tree of the current channel of Channel 1 comprising stream 1 with packet 1 under stream 1 is shown in FIG. 7a. Another exemplary authentication tree of the current channel of Channel 1 comprising streams 1 and 2 with packets 1 and 2 under stream 1 and frames F1-F8 under stream 2 is illustrated in FIG. 7b. Alternatively, each of the F1 to F8 can comprise a group or groups of pictures of a predetermined time interval. Yet another exemplary authentication tree for Channel 1 and Channel 2 with packet 1a, packet 1b, frame 1a and frame 1b under current Channel 1 and packet 2a, packet 2b, frame 2a, frame 2b under current Channel 2 is illustrated in FIG. 7c.

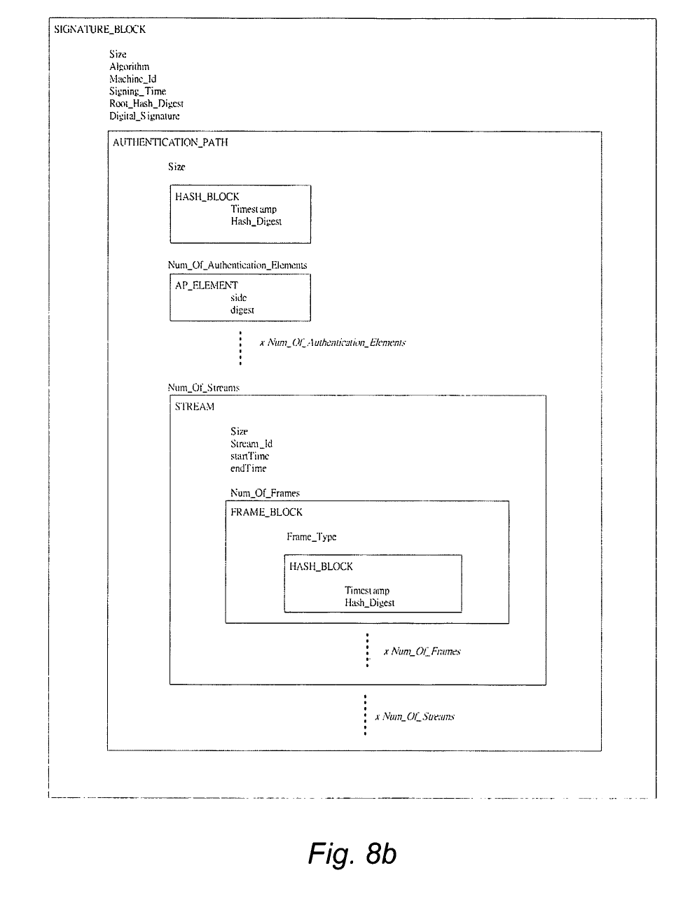

The video signature blocks (VSB) for various consequential time intervals are schematically shown in FIG. 8. A more detailed block diagram of a VSB for a time period I is shown in FIG. 8a. The VSB of FIG. 8a comprises information of the VSB, such as, for example, the signing time and the machine ID, the root hash value, the digital signature, the authentication path of the channel, information of the streams, information of packets, hash values of the last (previous) packet in stream 1, information of stream 2 and the hash values of its packets and information of other streams and the hash values of the other streams.

The data structure of the VSB of FIG. 8a in a programming perspective is shown in FIG. 8b. In this preferred embodiment, the number of video signatures generated is equal to the number of authentication tree formed, since there is a signature for each authentication tree. In other words, the number of signatures generated does not depend on the amount of data. Instead, the frequency of video signature generation is determined by the system design and is generated at predetermined time intervals. For example, the predetermined time interval may be set at 1 second in which case an authentication tree will be formed per second. In that particular time interval, a number of packets and frames will arrive at different channels. The hash generation unit will calculate the hash values according to the contents of the packets and frames and the hash values are fed to the signature generation unit which in turn forms the basis of a corresponding authentication tree. The root value of the authentication tree will be digitally signed for transmission when the authentication tree is built. The authentication method is particularly efficient for video transmission since a digital signature can be applied for a group of pictures without the need of individual digital signature for each of the I- or P-frames.

Another important feature of this authentication method is the time-based signature generation. More particularly, to reduce computational overheads, the time intervals between consecutive signature generations can be adjusted in accordance with system requirements. This flexibility enables the method to be applicable to system of different computational power. For example, digital signatures may be generated at the rate of one signature per 10 seconds for a low-end system while the digital signatures may be generated at a higher rate for a higher-end system.

Furthermore, if a medium content file, for example, packet 1 is tampered, the error in the computed hash values will be propagated upwards to the root. The erroneous hash value when compared with the hash values of the intermediate nodes of the authentication tree can be utilized to facilitate identification of the particular medium content files which has been tampered. This will enable a quick and efficient identification of a particular content file which has been tampered. For example, if the tampered file is a P-frame in the MPEG-4 system, the file may be discarded without seriously affecting the quality of the video whilst maintaining the authenticity of the video compared to traditional schemes in which the digital signature generation rate is dependent on the number of data blocks or the number of multi-media channels, the authentication method of this invention represents a substantial improvement.

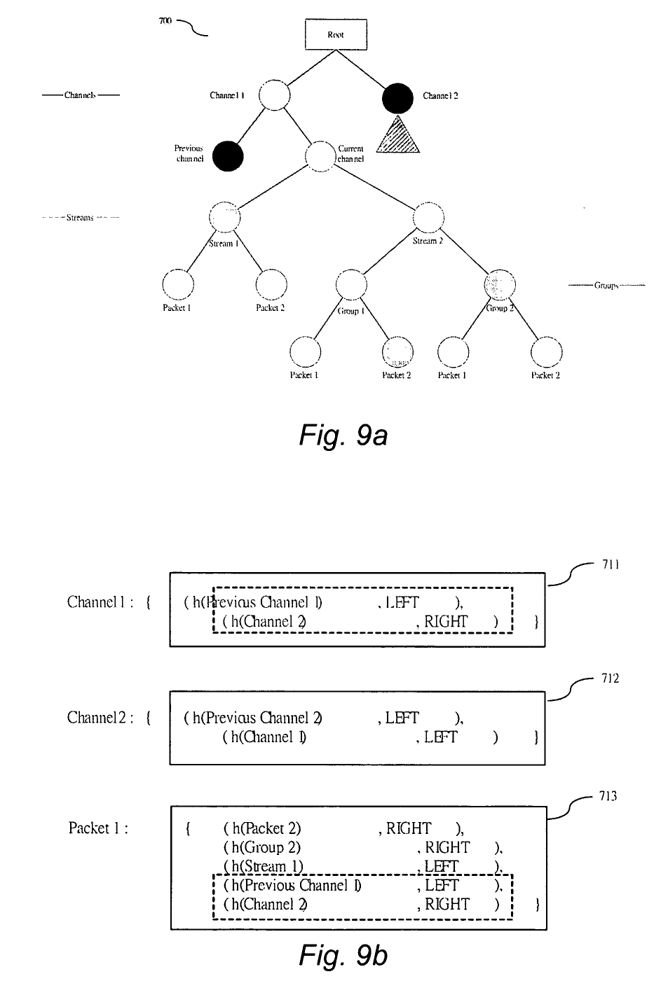

Another exemplary partial authentication tree is shown in FIG. 9a in which a complete authentication tree of the current channel of Channel 1 is shown. Specifically, the current channel of Channel 1 comprises stream 1 and stream 2 with packets 1 and 2 arranged under stream 1 and groups of pictures 1 and 2 arranged under stream 2. The authentication paths for Channel 1, Channel 2 and packet 1 are shown in FIG. 9b. More particularly, it will be noted from FIG. 9b that the authentication path information of Channel 1 is also contained in that of packet 1, as more particularly shown in the dotted boxes in the blocks 711 and 713 of FIG. 9b.

From the above examples, it will be appreciated that although an authentication tree is constructed from multi-medium data streams of the various channels, only the authentication tree root signature, the authentication path information and the medium content data to be authenticated are required to be available during the verification process.

While the present invention has been explained by reference to the examples or preferred embodiments described above, it will be appreciated that those are examples to assist understanding of the present invention and are not meant to be restrictive. Variations or modifications which are obvious or trivial to persons skilled in the art, as well as improvements made thereon, should be considered as equivalents of this invention.

Furthermore, while the present invention has been explained by reference to video data or multi-medium data files, it should be appreciated that the invention can apply, whether with or without modification, to other multi-medium data or video only data without loss of generality.

1. A method of processing a plurality of digital data files including at least one group of medium data files for constituting a sequence of events or activities of a time interval for secure delivery of the digital data files, the method comprising the steps of:—
(a) processing a plurality of digital data files so as to generate a file identification value for each digital data file, wherein the file identification value of a digital data file is an one-way arithmetic value characteristic of the data content of the digital data file;
(b) processing the file identification values to generate an authentication root value, the authentication root value being an one-way arithmetic value characteristic of the plurality of file identification values;
(c) encrypting the root value; and
(d) grouping the encrypted authentication root value and a selected plurality of digital data files with a set of authentication information for delivery, wherein the set of authentication information is derived from the file identification values and is for deriving a test root value when in combination with said selected plurality of digital data files, and wherein the test root value is for comparison with the authentication root value to detect tampering of said selected plurality of data files.

2. A method according to claim 1, wherein said set of authentication information for deriving a test root value contains authentication data obtained from one-way arithmetic operation of digital data files not selected for grouping.

3. A method according to claim 1, wherein the selected plurality of digital data files comprising at least a group of medium data files, said group of medium data files comprising a stream of video or moving pictures and/or an audio stream of a time interval.

4. A method according to claim 1, wherein the plurality of digital data files is from a plurality of physical channels and said selected plurality of digital data files selected for delivery comprises a selected group of medium data files from one of said plurality of physical channels, said selected group of medium data files comprising a stream of video or moving pictures and/or an audio stream of a time interval.

5. A method according to claim 4, wherein said set of authentication information for deriving a test root value from said selected plurality of digital data files comprises an intermediate file identification value, said intermediate file identification value being a characteristic value derived from digital data files of another physical channel through one-way arithmetic operations and being characteristic of said digital data files of said another physical channel.

6. A method according to claim 5, wherein said set of authentication information for deriving a test root value comprises an additional intermediate file identification value, said additional intermediate file identification value being a characteristic value derived from digital data files of all remaining physical channel through one-way arithmetic operations and being characteristic of said digital data files of said remaining physical channels.

7. A method according to claim 4, wherein said group of medium data files comprises a picture data file and a plurality of variation data files, each said variation data file containing information of changes with respect to said picture data file, said picture data file and said plurality of variation data files together forming a group of moving picture data files.

8. A method according to claim 7, wherein said group of moving picture data files comprises data files in MPEG-4 or like formats.

9. A method according to claim 1, wherein said group of medium data files constituting a stream of video or moving pictures data files of a current time interval is selected for delivery with said encrypted root value, said group of medium data files being processed by one-way arithmetic operations to generate an intermediate file identification value which is characteristic of said group of medium data files, the intermediate file identification value of said group of medium data files of said current time interval being processed with the intermediate file identification value of the same group of medium data files of a previous time interval for generation of said root value, the intermediate file identification value of said previous time interval being also transmitted as part of said set of authentication information.

10. A method according to claim 1, wherein the plurality of digital data files from a plurality of physical channels, at least some of the physical channels being for sending moving picture data files at various time intervals, the file identification value of a group of medium data files delivered in a previous time interval being processed with that of a current group of medium data files to obtain the root value.

11. A method according to claim 10, wherein the file identification values of the plurality of digital data files from a physical channel being processed to form an intermediate node identification value, the intermediate node identification values of the plurality of physical channels being processed together to form the root value.

12. A method according to claim 1, wherein the file identification value of a digital data file is generated by a one-way function, wherein said one-way function is selected from a group including a hash function.

13. A method according to claim 12, wherein said one-way function is characterized by the return of a hash value of a pre-determined data length irrespective of the content of said digital data file, said hash value being specific to the content of said digital data file.

14. A method according to claim 1, wherein information relating to the time of generation of the medium content files is also grouped and encrypted for delivery of the selected plurality of digital data files, wherein said selected selection plurality of digital files comprises at least one group of said medium data files.

15. A method according to claim 1, wherein the plurality of digital data files being is from a plurality of physical channels and the selected plurality of digital data files is selected for transmission comprising a group of moving picture data files from a physical channel, information relating to identity of said physical channel is also grouped and encrypted for transmission.

16. A method according to claim 15, wherein the medium data file includes multi-media data such as video, audio, text overlay, motion vector and like data.

17. A method according to claim 15, wherein the authentication root value is encrypted by a digital signature scheme before delivery.

18. A method according to claim 15, wherein the digital signature generation is by a publicly verifiable cryptographic key infrastructure.

19. A method according to claim 1, wherein the method comprises construction of an authentication tree from said digital data files, said authentication tree having a root characterized with said root value, a plurality of leave nodes formed from the file identification values of said plurality of digital data files and a plurality of intermediate nodes derived from said leave nodes through one-way arithmetic operations of said file identification values, said intermediate nodes being intermediate the leave nodes and the root, said authentication tree being characterized by a plurality of authentication paths and each intermediate node is associated with an authentication path providing for establishment of the root value of the authentication tree from said intermediate node and the associated authentication paths associated with said intermediate node, the authentication path of an intermediate node is characterized by intermediate nodes which are siblings of said intermediate node, wherein said selected plurality of digital data files which are grouped for delivery comprising a plurality of medium data files for constituting a group of pictures and being under an intermediate node.

20. A method according to claim 19, wherein said group of digital medium data files comprises video data files generated and is transmitted at different time intervals, the authentication path of a later transmitted group of pictures comprising the intermediate node of an earlier transmitted group of digital medium data files.

21. A method according to claim 1, wherein the group of medium data files is provided in AVI format and contains a video signature block, the video signature block comprising file identification values of the medium data files and authentication paths.

22. A method according to claim 21, wherein the medium data files comprises a video signature stream, a video stream, an audio stream, a text overlay stream and a motion vector stream which are multiplexed to form an AVI stream.

23. A method according to claim 21, wherein the video signature block further comprises time information relating to the medium data files.

24. A method of verifying integrity of delivered medium data files processed according to the method of claim 1 and further comprising the steps of:—
e) decrypting a received root value;
f calculating the file identification values from the received medium data files;
g) calculating a root value from said file identification values and said set of authentication information by one-way arithmetic operations; and
h) comparing for equality the calculated root value and the received encrypted root value.

25. An apparatus for processing digital medium data files for transmission, the apparatus comprising:
a) a hash value generator for processing a plurality of digital medium data files so as to generate a plurality of file identification values, the file identification value of a digital medium data file is characteristic of its medium data;
b) an authentication tree generator for processing the plurality of file identification values to form an authentication tree, the authentication tree having a root with a root value and with the plurality of digital medium data files forming leaves of the authentication tree, the authentication tree being characterized by a plurality of authentication paths, each digital medium data file being associated with an authentication path such that the root value of the authentication tree can be established from an digital medium data file and its associated authentication path;
c) an encryption unit for encrypting the root value of the authentication tree; and
d) a group unit for grouping the encrypted root value, a plurality of digital medium data files and their respective associated authentication paths for transmission.

26. An apparatus for verifying integrity of medium data files transmitted according to the method of claim 25 and comprising:—
e) a decryption unit for decrypting received root value;
f) processing unit for calculating the file identification values from the received medium data files;
g) a processing unit for constructing an authentication tree using the file identification values and the authentication paths received and calculating a root value of the authentication tree; and
h) a comparison unit for comparing for equality the calculated root value and the received encrypted root value.
